(19) United States
(12) Patent Application Publication
(10) Pub. No.: US 2025/0389372 A1
(43) Pub. Date: Dec. 25, 2025

(54) AUTOMATICALLY ADJUSTING MONITOR SCREEN ANGLE AND HEIGHT

(71) Applicant: DISH Network Technologies India Private Limited, Bangalore (IN)

(72) Inventors: Manigandan Subramani, Tamil Nadu (IN); PraveenKumar Gopalakrishnan, Mangalore (IN); Ramegowda Thimmegowda, Karnataka (IN); Hariprasanth Mohanraj, Tamil Nadu (IN); Anandaraj Philips, Tamil Nadu (IN); Vikram Balaraja Shetty, Bengaluru (IN); Dileep Puramana, Malappuram (IN); Jami Manasa, Andhra Pradesh (IN)

(21) Appl. No.: 18/753,881

(22) Filed: Jun. 25, 2024

(51) Int. Cl. F16M 11/08; F16M 11/24; G01G 23/36; G01P 13/00; G06F 3/01; G06T 7/70; H04W 4/029

(52) U.S. Cl. CPC F16M 11/08; F16M 11/24; G01G 23/36; G01P 13/00; G06F 3/011; G06T 7/70; H04W 4/029; G06T 2207/10048

(57) ABSTRACT

A device receives a first signal where the first signal includes information about a location or a position of a user. The device determines the location or the position of the user based on the information. The device may determine at least one of an adjusted height value or an adjusted angle value of a display based on the location or the position of the user. The device sends to a control motor a second signal, the second signal including the adjusted angle value or the adjusted height value. Responsive to receiving the second signal, a control motor performs at least one of: adjust a rotatable bracket based on the adjusted angle value, or adjust an adjustable height pole based on the adjusted height value. The controller device may determine the location or the position of the user based on the user profile.

### BACKGROUND

To watch streaming content via a monitor can be uncomfortable and possibly injurious for a viewer when the monitor is not ergonomically facing the viewer. This situation can be tiresome or even serious from a health perspective when a person is viewing content for an extended period of time.

### SUMMARY

In some aspects, the techniques described herein relate to a method including: receiving, at a controller, a first signal from a device wherein the first signal includes information about at least one of a location or a position of a user; determining, by the controller, at least one of the location or the position of the user based on the information in the first signal; determining, by the controller, at least one of an adjusted height value or an adjusted angle value of a monitor based on the at least one of the location or the position of the user; sending by the controller to a control motor, a second signal, wherein the second signal includes at least one of the adjusted angle value or the adjusted height value; responsive to receiving the second signal, the control motor performing at least one of: adjusting a rotatable bracket based on the adjusted angle value; or adjusting an adjustable height pole based on the adjusted height value; wherein the rotatable bracket and the adjustable height pole are communicably connected to the control motor.

In some aspects, the techniques described herein relate to a method, wherein the device is a thermal sensor and the information includes one or more thermal images of the user; wherein determining the at least one of the location or the position of the user further includes: inputting, by the controller, the thermal images into a machine learning algorithm and obtaining from the machine learning algorithm a predicted adjusted height value or a predicted adjusted angle value of the monitor; and assigning the predicted adjusted height value or the predicted adjusted angle value of the monitor to the adjusted height value or adjusted angle value of the monitor.

In some aspects, the techniques described herein relate to a method, wherein the device is a motion detector sensor and the information about the at least one of the location or the position of the user indicates movement detected with a line of sight of the motion detector sensor.

In some aspects, the techniques described herein relate to a method, wherein the device is a weight sensor and the information about the at least one of the location or the position of the user includes a weight value, the method further including: comparing the weight value with a threshold weight value; determining that the weight value is greater than the threshold value; and assigning a predetermined adjusted height value or a predetermined adjusted angle value of the monitor to the determined adjusted height value or adjusted angle value of the monitor.

In some aspects, the techniques described herein relate to a method, wherein the device is a millimeter wave sensor and the information about the at least one of the location or the position of the user includes a range, a velocity, and an angle of the user.

In some aspects, the techniques described herein relate to a method, wherein the device is a Wi-Fi-based device, the information about the at least one of the location or the position of the user is a detection signal, signaling presence of a person, and determining the at least one of the location or the position of the user further includes: transmitting information indicating the detection signal to the cloud; and receiving from the cloud at least one of the location or the position of the user.

In some aspects, the techniques described herein relate to a method, wherein the device is a remote controller, the information about the at least one of the location or the position of the user includes information about a location of the remote control, and determining the at least one of the location or the position of the user is further based on the location of the remote control.

In some aspects, the techniques described herein relate to a method, wherein the device is a device worn or carried by the user.

In some aspects, the techniques described herein relate to a method, wherein the device is any of: a device including ultra wideband or low energy based tags; a smart watch; and a digital phone; wherein the device is configured with an accelerometer or a gyro meter.

In some aspects, the techniques described herein relate to a method, wherein the device is a camera.

In some aspects, the techniques described herein relate to a method, wherein the controller is configured into a first set-top box.

In some aspects, the techniques described herein relate to a method, further including: receiving, at a second controller, a third signal from the device wherein the third signal includes information about at least one of a new location or a new position of the user, wherein the second controller is configured into a second set-top box in a room different than a room of a location of the first set-top box, and automatically streaming content on the second set-top box based on the content that was streaming on first set-top box.

In some aspects, the techniques described herein relate to a method, wherein the monitor is a TV, laptop, or tablet.

In some aspects, the techniques described herein relate to a method, further including: determining, by the controller, that the monitor is turned off; sending by the controller to the control motor, a fourth signal, wherein the fourth signal includes at least one of a default angle value or a default height value; responsive to receiving the fourth signal, the control motor performing at least one of: adjusting the rotatable bracket to achieve the default angle value; or adjusting the adjustable height pole to achieve the default height value.

In some aspects, the techniques described herein relate to a method, further including: receiving, by the controller, a voice command to turn the monitor into a particular direction, the voice command including at least one of a vocalized height value or a vocalized angle value; and determining, by the controller, the adjusted height value or the adjusted angle value of a monitor based on the at least one of vocalized height value or the vocalized angle value.

In some aspects, the techniques described herein relate to a method, further including: responsive to determining, by the controller, the at least one of the location or the position of the user based on the information in the first signal and before determining, by the controller, the at least one of the adjusted height value or the adjusted angle value of a monitor based on the at least one of the location or the position of the user, confirming that a predetermined amount of time has passed and that the at least one of the location or the position of the user has not changed.

In some aspects, the techniques described herein relate to a method, further including: receiving, at the controller, a fifth signal from a second device wherein the fifth signal includes information about at least one of a location or a position of a second user; determining, by the controller, the at least one of the location or the position of the second user based on the information in the fifth signal; and wherein determining, by the controller, at least one of an adjusted height value or an adjusted angle value of a monitor based on the at least one of the location or the position of the user further includes incorporating the at least one of the location or the position of the second user.

In some aspects, the techniques described herein relate to a method, further including: when the location is determined by the controller from the information in the first signal but the position is not determined by the controller from the information in the first signal, the controller: determining the position based on a user profile; and sending the position to the control motor; and when the position is determined by the controller from the information in the first signal but the location is not determined by the controller from the information in the first signal, the controller: determining the location based on the user profile; and sending the location to the control motor.

In some aspects, the techniques described herein relate to a system, including: a controller configured to receive a first signal from a device wherein the first signal includes information about at least one of a location or a position of a user; wherein the controller is configured to determine at least one of the location or the position of the user based on the information in the first signal; wherein the controller is configured to determine at least one of an adjusted height value or an adjusted angle value of a monitor based on the at least one of the location or the position of the user; wherein the controller is configured to send to a control motor, a second signal, wherein the second signal includes at least one of the adjusted angle value or the adjusted height value; and a control motor configured to, responsive to receiving the second signal, adjust a rotatable bracket based on the adjusted angle value; or adjust an adjustable height pole based on the adjusted height value; wherein the rotatable bracket and the adjustable height pole are communicably connected to the control motor.

In some aspects, the techniques described herein relate to a method including: predicting, by a controller, at least one of a location or a position of a user based on a profile of the user; determining, by the controller, at least one of an adjusted height value or an adjusted angle value of a display based on the at least one of the location or the position of the user; sending by the controller to a control motor, a first signal, wherein the first signal includes the at least one of the adjusted angle value or the adjusted height value; responsive to receiving the first signal, the control motor performing at least one of: adjusting a rotatable display bracket based on the adjusted angle value; or adjusting an adjustable height pole based on the adjusted height value; wherein the rotatable display bracket and the adjustable height pole are each communicably connected to the control motor.

### BRIEF DESCRIPTION OF THE DRAWINGS

FIG. 1 is a schematic diagram of a viewing environment in which a viewer cannot easily see the TV monitor from their viewing placement, according to the prior art.

FIG. 2 is a schematic diagram of the living room environment showing a person sitting on couch and still not able to see the screen of TV monitor, according to the prior art.

FIG. 3 is a schematic diagram of an example living room environment, according to an embodiment.

FIG. 4 is a schematic diagram of an example living room environment, in which a person, sitting on a couch, can view an adjusted TV monitor with ease, according to an embodiment.

FIG. 5 is a schematic diagram showing the various inputs to the system for an improved viewing experience of a viewer, according to an embodiment.

FIG. 6 is a schematic diagram showing the elements and relationships of such monitor stand, according to an embodiment.

FIG. 7 is a schematic diagram showing a TV monitor in an optimum height and at an optimum angle between two viewers, according to an embodiment.

FIG. 8A is a flowchart of an example method for automatically adjusting a display angle and height, according to an embodiment.

FIG. 8B is a flowchart of an example method for automatically adjusting a display angle and height, according to an embodiment.

FIG. 9 is a block diagram illustrating an overview of devices on which some implementations of the disclosed technology can operate.

FIG. 10 is a block diagram illustrating an overview of an environment in which some implementations of the disclosed technology can operate.

FIG. 11 is a block diagram illustrating components which, in some implementations, can be used in a system employing the disclosed technology.

### DETAILED DESCRIPTION

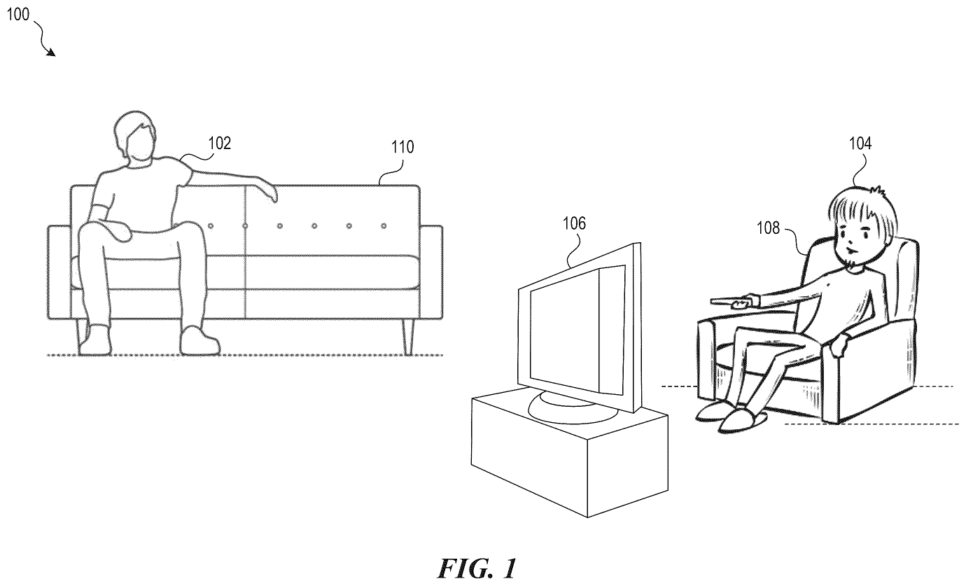

Aspects of the present disclosure are directed to methods and systems (“system”) for automatically adjusting the screen angle and height of a monitor, such as a television (“TV”), based on at least one of the viewer's location or position, such as sitting on a couch, for the viewer to get a better viewing experience. It should be appreciated that embodiments may refer to “TV” as opposed to the more general monitor. However, such reference to TV is by way of example, by specific embodiment, for understanding purposes, and to avoid obfuscating the reader. An example of the problem can be understood with reference to FIG. 1.

FIG. 1 is a schematic diagram of a viewing environment, such as a living room environment 100, in which a viewer, Person A 102, cannot easily see the display 106 (e.g., TV monitor) from a first viewing placement 110 (e.g., on the couch), according to the prior art. In contrast, the other viewer, Person B 104, happens to be fortunate by sitting in a second viewing placement 108 (e.g., in the reclining chair) to which the display 106 happens to face.

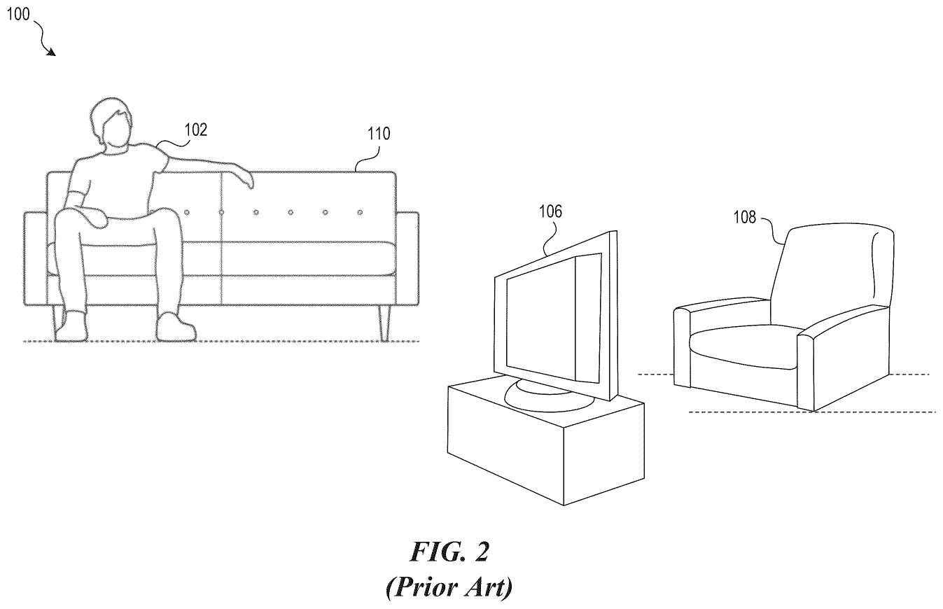

An example of the problem can be understood with reference to FIG. 2. FIG. 2 is a schematic diagram of the living room environment 100 showing Person A 102 at the first viewing placement 110 and still cannot see the screen of display 106, according to the prior art. In this example, it does not make sense for display 106 to be facing the second viewing placement 108 when no one is sitting in such chair.

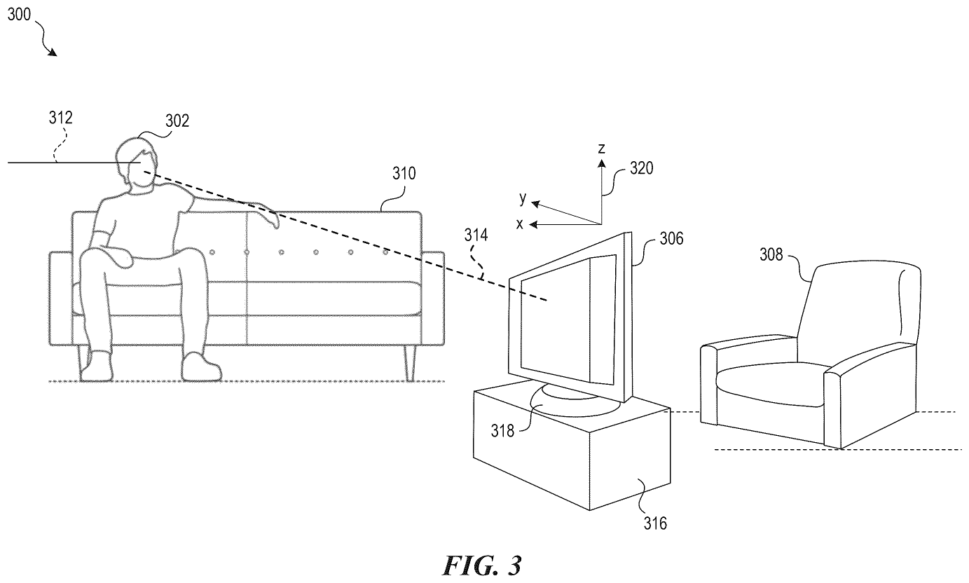

The innovation can be understood with reference to FIG. 3. FIG. 3 is a schematic diagram of an example living room environment 300, according to an embodiment. A controller 316 had been previously placed near the display 306. The controller 316 is communicably connected to the display 306 and elements of the display stand 318. That is, display stand 318 is configured with an adjustable rotatable TV monitor bracket, an adjustable height pole, and a control motor (all not shown), where the controller 316 is communicably connected to the control motor for moving the adjustable rotatable TV monitor bracket and the adjustable height pole, discussed in further detail below. In this example implementation, Person D 302 sits down on couch in the first viewing placement 310. The controller 316 is configured to be able to determine the location and position of Person D 302. For example, controller 316 is configured to receive information about viewer position and location and determine such from the received information.

In an embodiment, the location and the position of an entity (e.g., Person D 302) are each described with respect to a three dimensional coordinate system (e.g., as shown by the visual x-y-z coordinate graph 320 in FIG. 3). In accordance with embodiments herein, the location of the entity (e.g., Person D 302) is defined as the x-y coordinates with respect to a predefined point of reference (e.g., predefined as at the display 306, the display stand 318, or the controller 316). Further, the x-y coordinates can be defined as an angle (e.g., in polar coordinates) with respect to the predefined point of reference or origin of at least a two dimensional Cartesian coordinate system. In accordance with embodiments herein, the position of the entity (e.g., Person D 302) is defined as the z-coordinate of a three dimensional Cartesian coordinate system, the z-coordinate with respect to the predefined point of reference or origin. Thus in some embodiments, references to the location of a person herein include the x-y coordinates, polar angle, or just angle of the person with respect to a predefined origin and references to the position of the person herein include the z-coordinates or height of the person with respect to a predefined origin of a coordinate axis in three dimensions.

More specifically, controller 316 is configured to be able to determine the height 312 of Person D 302 and the angle 314 (e.g., the projection of 314 on the predetermined x-y axis, such as that of visual x-y-z coordinate graph 320) of display 306 relative to Person D 302. As in the previous examples, the display 306 is presently facing the reclining chair in the second viewing placement 308, which can be inconvenient and possibly even ergonomically harmful to Person D 302.

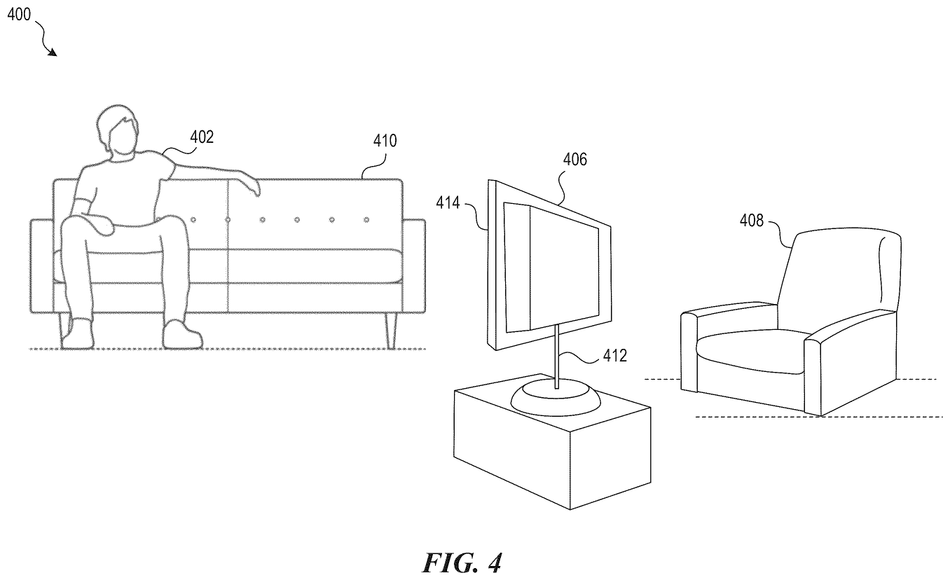

The innovation can be understood with reference to FIG. 4. FIG. 4 is a schematic diagram of an example living room environment 400, in which a Person C 402, sitting on a couch in the first viewing placement 410, can view an adjusted display 406 with ease, according to an embodiment. In this example, the TV monitor had been facing the reclining chair at the second viewing placement 408. However, consistent with embodiments herein, the location and position of Person C 402 was detected or determined by the innovative system and thus caused the adjusted display 406 to achieve an adjusted display height 412 and an adjusted display angle 414 (e.g., as with respect the facing of display 306 in FIG. 3), as shown.

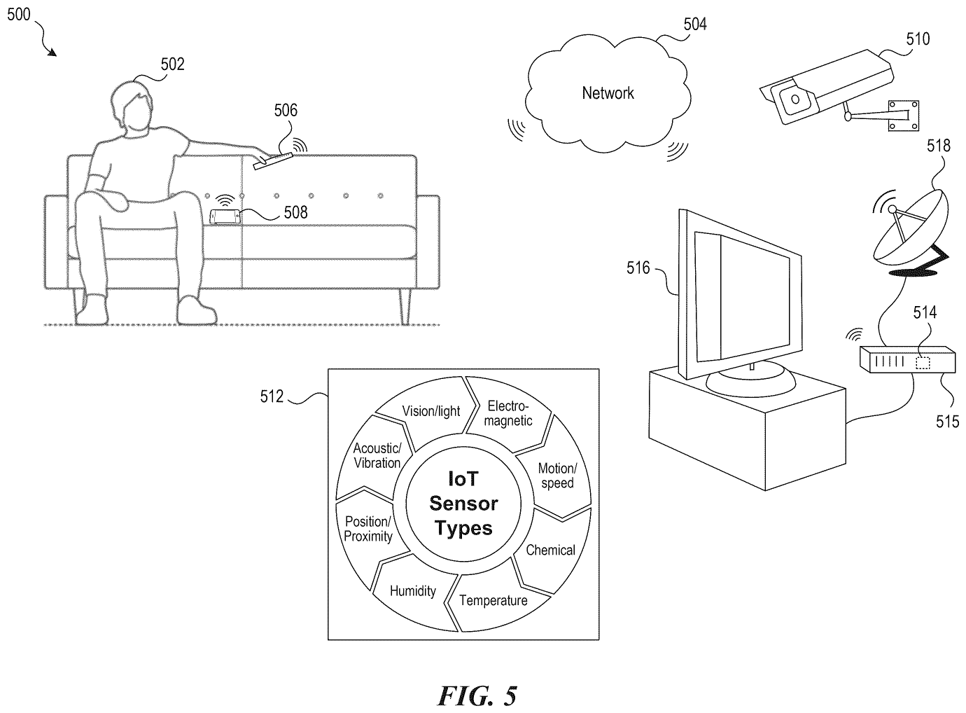

The innovation further can be understood with reference to FIG. 5. FIG. 5 is a schematic diagram 500 showing the various inputs to the system for an improved viewing experience of a viewer, e.g., Person E 502, according to an embodiment. In an embodiment, the controller 514, for example as discussed above, is embedded in a set-top box 515, which is communicably connected to the display 106. Typically, the set-top box 515 is communicably connected to satellite communication 518 to achieve streaming of digital content or obtain access to the internet. Consistent with embodiments herein, the controller 514 is configured to receive suitable inputs from various devices of the internet of things category 512, discussed in further detail below. Examples of such devices include but are not limited to sensing devices, acoustic devices, cameras, electric, and infrared (IR) sensing devices. Some sensors can communicate with the controller 514 over the network 504, such as the local wide area network, also discussed in further detail below. In an embodiment, the controller 514 is configured to query and/or receive the informational input about the viewer's location and position from the remote device 506. Further, consistent with embodiments herein, the controller 514 is configured to receive informational input about the viewer's location and position from a viewer's accessory 508 (e.g., the viewer's smartphone) or a camera 510. Each of the above-mentioned input sources are discussed in further detail below.

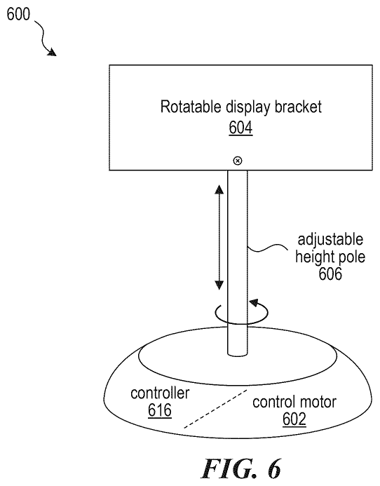

An implementation of a display (e.g., monitor, TV, etc.) stand 318 in accordance with embodiments herein can be described with reference to FIG. 6. FIG. 6 is a schematic diagram showing the elements and relationships of a display stand 600 (e.g., similar to display stand 318), according to embodiments herein. The display stand 600 includes a rotatable display bracket 604 which is communicably connected to a controller 616, (e.g., similar to the controller 316 of FIG. 3). Further, the display stand 600 includes an adjustable height pole 606 that is connected to the rotatable display bracket 604. Thus, as the adjustable height pole 606 moves up and down, it moves the rotatable display bracket 604 up and down, which in turn, moves the TV display attached or mounted thereto up and down, respectively. In an embodiment, each of the rotatable display bracket 604 and the adjustable height pole 606 are connected to a control motor 602. Thus, when the control motor 602 receives the appropriate signal from the controller, the control motor 602 moves at least one of the angle of the rotatable display bracket 604 to the desired angle or the height of the adjustable height pole 606 to the desired height.

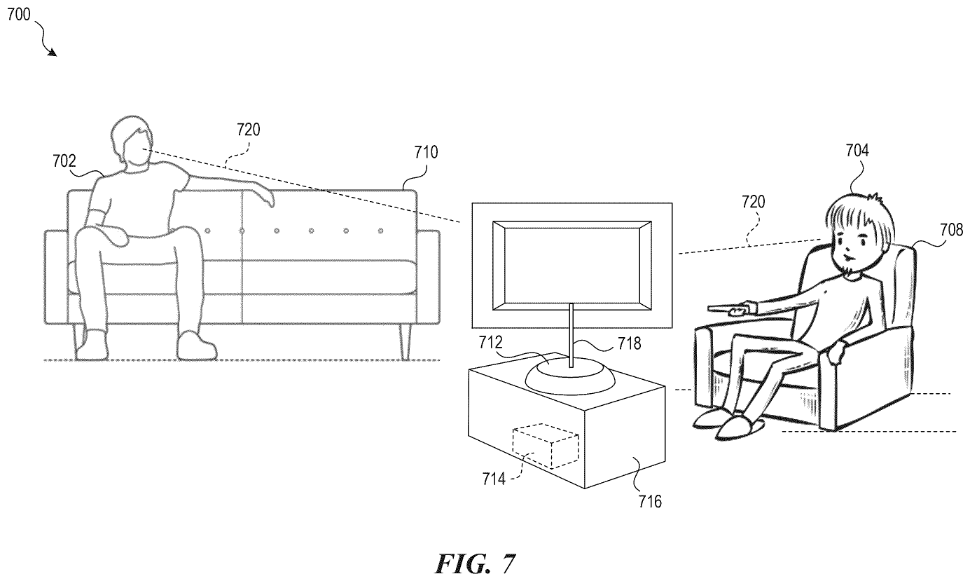

An example of a display stand 600 (or display stand 318) achieving at least one of an adjusted angle or height in accordance with embodiments herein can be described with reference to FIG. 7. FIG. 7 is a schematic diagram showing a display (e.g., TV monitor) at an optimum height and at an optimum angle between two viewers 700, in accordance with an embodiment. In the example implementation, first viewer, Person F 702, and a second viewer, Person G 704, have sat down on a couch in the first viewing placement 710 and a reclining chair in the second viewing placement 708, respectively. The TV was in a default placement (not shown). An example of such default placement can be viewed in FIG. 1. In accordance with embodiments herein, a display base containing a controller and control motor 712 (e.g., as discussed above) is embedded or nearby to a set-top box 714 (e.g., as discussed above), each shown to be located inside a TV cabinet 716. Such controller and control motor received informational input about the locations and positions of Person F 702 sitting on the couch in the first viewing placement 710 and Person G 704 sitting on the reclining chair in the second viewing placement 708. The display base containing the controller and control motor 712 determined an adjusted TV height 718 and an adjusted TV angle 720 by techniques discussed below. The adjusted TV height 718 and the adjusted TV angle (not shown) have been calculated by processes operating on by the controller and control motor of the display base 712, to be the optimized height and angle for the enjoyment of the optimized view 720 for Person F 702 and Person G 704. It should be appreciated that the controller is not limited to being inside the display base. For instance, and as mentioned above, the controller can be in the set-top box 714.

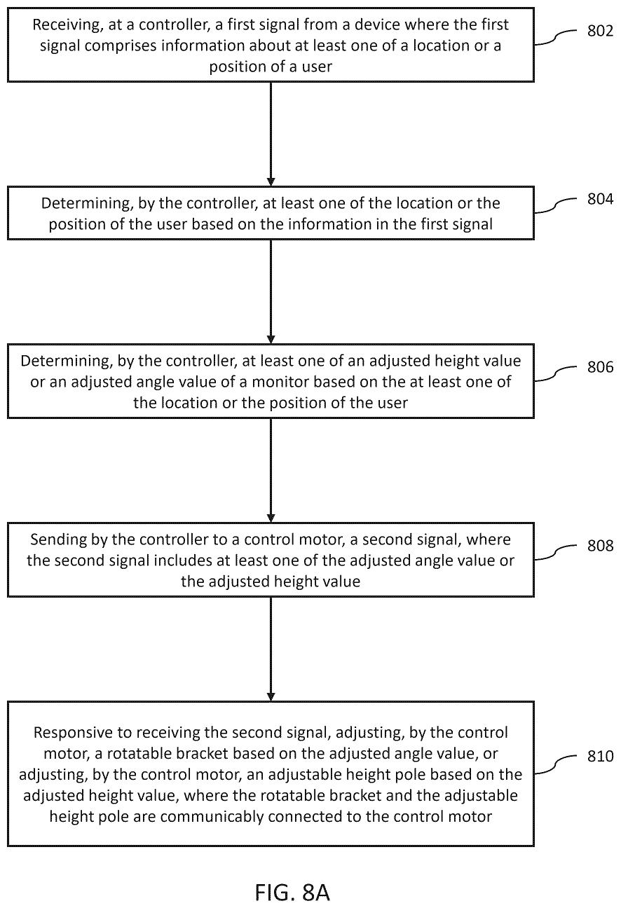

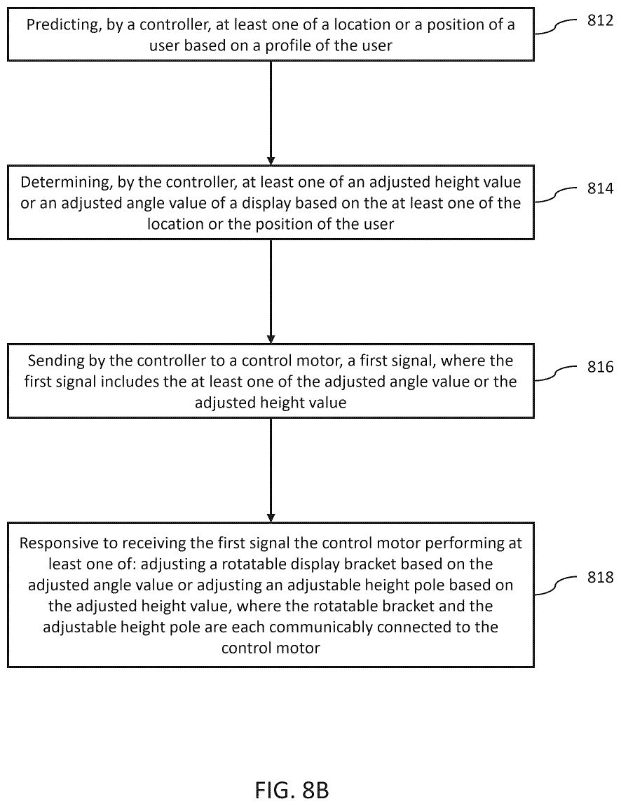

The innovation can be understood with reference to FIG. 8A. FIG. 8A is a flowchart of an example method for automatically adjusting a display angle and height, according to an embodiment.

At step 802, a controller (e.g., controller 316, controller 514, display base containing a controller and control motor 712) receives a first signal from a device (e.g., remote device 506, an accessory 508, an internet of things related device 512, camera 510, and network 504) where the first signal comprises information about at least one of a location (e.g., angle 314) or a position (e.g., height 312) of a user (e.g., Person C 402, Person D 302, Person E 502, and Person F 702).

At step 804, the controller (e.g., controller 316, controller 514, display base containing a controller and control motor 712) determines at least one of the location or the position (e.g., angle 314 or height 312, respectively) of the user (e.g., Person C 402, Person D 302, Person E 502, and Person F 702) based on the information in the first signal.

At step 806, the controller (e.g., controller 316, controller 514, display base containing a controller and control motor 712) determines at least one of an adjusted height value (e.g., adjusted display height 412 or adjusted TV height 718) or an adjusted angle value (e.g., adjusted display angle 414 or adjusted TV angle 720) of a monitor (e.g., display 306) based on at least one of the location or the position (e.g., angle 314 or height 312, respectively) of the user (e.g., Person C 402, Person D 302, Person E 502, and Person F 702).

At step 808, the controller (e.g., controller 316, controller 514, display base containing a controller and control motor 712) sends to a control motor (e.g., control motor 602), a second signal, where the second signal includes at least one of the adjusted angle value (e.g., adjusted display angle 414 or adjusted TV angle 720) or the adjusted height value (e.g., adjusted display height 412 or adjusted TV height 718).

At step 810, responsive to receiving the second signal, the control motor (e.g., control motor 602) adjusts a rotatable bracket (e.g., rotatable display bracket 604) to achieve the adjusted angle value (e.g., adjusted display angle 414 or adjusted TV angle 720) or adjusts an adjustable height pole (e.g., adjustable height pole 606) to achieve the adjusted height value (e.g., adjusted display height 412 or adjusted TV height 718), where the rotatable bracket and the adjustable height pole are communicably connected to the control motor.

The innovation can be understood with reference to FIG. 8B. FIG. 8B is a flowchart of an example method for automatically adjusting a display angle and height, according to an embodiment.

At step 812, the controller (e.g., controller 316, controller 514, display base containing a controller and control motor 712) predicts at least one of a location and a position (e.g., height 312 and angle 314) of the user (e.g., Person C 402, Person D 302, Person E 502, and Person F 702) based on a profile of the user.

At step 814, the controller (e.g., controller 316, controller 514, display base containing a controller and control motor 712) determines at least one of an adjusted height value (e.g., adjusted display height 412 or adjusted TV height 718) or an adjusted angle value (e.g., adjusted display angle 414 or adjusted TV angle 720) of a display (e.g., display 306) based on the at least one of the location or the position (e.g., angle 314 or height 312, respectively) of the user (e.g., Person C 402, Person D 302, Person E 502, and Person F 702).

At step 816, the controller (e.g., controller 316, controller 514, display base containing a controller and control motor 712) sends to a control motor (e.g., control motor 602), a first signal, where the first signal includes at least one of the adjusted angle value (e.g., adjusted display angle 414 or adjusted TV angle 720) or the adjusted height value (e.g., adjusted display height 412 or adjusted TV height 718).

At step 818, responsive to receiving the first signal, the control motor (e.g., control motor 602) performs at least one of: adjusts a rotatable bracket (e.g., rotatable display bracket 604) based on the adjusted angle value (e.g., adjusted display angle 414 or adjusted TV angle 720) or adjusts an adjustable height pole (e.g., adjustable height pole 606) based on the adjusted height value (e.g., adjusted display height 412 or adjusted TV height 718), where the rotatable bracket and the adjustable height pole are each communicably connected to the control motor.

### Exemplary Embodiments

In accordance with embodiments herein, the technical problem can be described as how to automatically adjust the monitor (e.g., the TV) screen angle and height based on the viewer's sitting placement for the viewer to obtain a better viewing experience. Consistent with embodiments herein, the solution includes two steps at a high level. The first step (“Step 1”) includes identifying the individual's sitting location or position in one or more approaches. The second step (“Step 2”) includes adjusting the monitor's angle or height.

Consistent with embodiments herein, Step 1 includes any of or any combination of the following eight methodologies:
1. Processing artificial intelligence such as machine learning (“ML”) from thermal imaging;
2. Employing sensors such as passive infrared (“PIR”) to identify people's movement;
3. Employing weight sensors on common sitting placements;
4. Employing sensors based on millimeter (“mm”) waves to identify the person's location and position;
5. Using WiFi based location tracking;
6. By using the remote device for the monitor, the location or position of the user can be identified;
7. The person can carry an accessory such as but not limited to ultra wideband (“UWB”) or Bluetooth® Low Energy (“BLE”) based tags, smart watch, phone, etc. The set-top box (“STB”) can have the corresponding receiver, which can detect these accessories and locate the person. These accessories should be able to detect whether the person is wearing it or not by the accelerometer and gyrometer inside it.
8. Using a camera where there are no security concerns for example in common areas such as a gym, cafeteria, etc.
   Such eight approaches are implemented with the aid of at least one controller. In an embodiment, the type of controller can vary from simple microcontroller, which can be add-on to the existing TV system, to a System on Chip (SoC) which can run a sophisticated operating system such as for example but not limited to Android. The capability can vary based on the inputs such as the number of sensors as well as the complexity of the sensors. For example, if only a thermal PIR array is used, an 8-bit microcontroller also will be able to collect the data and process the data to get a placement of humans in the room. In a similar way, integrating multiple sensors can require higher processing power and it can be integrated with the main SoC of the STB as well. The controller can be dedicated to this purpose or it can be part of other systems.

Consistent with embodiments herein, Step 2 includes adjusting the monitor angle or height. Based on the information received by the controller from Step 1, the angle or height of the monitor can be adjusted as follows:
1. The monitor is placed, mounted, or attached to the stand, which has a rotatable bracket and adjustable height pole, each of which can be moved with the help of a motor. In some embodiments, there can be multiple types of motors which can be used depending on the requirements. It an embodiment, a kind of stepper motor and servo motor combination may provide precise angle movement. Any other motors also can be use based on the size and weight of the TV. It also may depend on the place where the TV is mounted. For example to fix the TV in wall a metal structure can be attached to the wall and the embodiment can include an attached stepper motor to each degree of freedom. It can have a minimum of three (3) degrees of freedom. Similarly, if the TV is placed on top of the table, then the mechanism can be a servomotor where the table base can rotate to adjust the viewing angle.
2. As mentioned above, the stand has a rotatable bracket and an adjustable height pole with one or more motors attached to the rotatable bracket and adjustable height pole. Then, the bracket can be rotated and the height pole moved higher or lower with the help of or by motors. In an embodiment, these motors are also controlled by the same controller as in Step 1. In an embodiment, the motor can be directly connected to the controller. In another embodiment, the motor can have a local microcontroller to control the motor. The microcontroller can communicate to the main controller through normal wireless communication such as but not limited to WiFi and BLE. The microcontroller can use low power communication such as LoRA, ZigBee, RF4CE, etc. based on the distance from main controller to motor controller. The communication can be also wired communication. In an embodiment, one command is the angle at which the rotatable bracket is to rotate and if it needs to be in sleep mode, etc.

### Additional Features

In an embodiment, when the person is going from one room to another and that room is empty, the same content he/she watched in the former room can be played in the new room automatically. This is due to an additional setting in the STB. Using the approach 4,5,6,7,8 mentioned in Step 1 above, the system can identify the person's movement, new location and/or position, or activity. This can be enabled or disabled by the user. It can also be customized. In an implementation, the enabled or disable option can be provided in the STB settings as a customization option. The same can be added to a remote button as well, so that a single press can toggle such functionality. Customization can also be via a voice command.

Further, in an embodiment, the system is configured to automatically turn off the TV once the person has left the room (and there are no others in the room) for a predetermined amount of time. Also, in an embodiment, the system is configured to automatically turn on the TV when the person has entered a room (and there are no others in the room) after a predetermined amount of time. For example, the TV is turned off and the person was watching some content in the hall. Then, once he's moving into the bedroom, automatically the content can be transferred (or shown from a different STB) to the bedroom and the system can turn off the TV inside the hall. This way the person has the freedom of where to watch the content, even if he's moving; he'll have the freedom of having multiple monitors for the same content.

In an embodiment, the system is configured to a central control system (e.g., the main controller to perform the processing of calculating the adjusting parameters) and to have multiple relatively smaller STBs, which are placed in each desired room. For instance, the system can be configured to have three different TV's, one TV is generally in the grand hall for example, which also has a main control system where the system receives the satellite signals. Then the innovation provides subsystems where the signals are transferred over such as via RF cable or Wi-Fi to the different rooms which are in the same house. By this embodiment, this is one of the ways which such devices are communicably connected.

In an embodiment, even though it's in a different TV, the setup box can be in the same ecosystem so that each of the setup boxes are communicably connected and once a person's moving from one to room to another room, the setup box from the room 1 can send a signal to the setup box for the room 2. Then the room 2 setup box knows the person is coming and that the person is watching a particular channel. That channel can directly display when the person enters and automatically adjust the height or angle, by referring to the person's virtual profile, via Wi-Fi and mm wave based identity tracking, or in accordance with the techniques described herein. Similarly, the other, the former STB knows that the person moved away and shuts it down there. The content, the continuity of the content is done through STBs communicating to one another when the system identifies the person as being the same and no one else is watching content on the TV in the second room that the person just entered. If it's a different person, then the system can play different content like a normal STB and automatically adjust the height or angle as described herein.

In an embodiment, a rotatable surface or rotatable table-like piece in the size of the bottom of a laptop/tablet is configured with one or more electric motors, where such laptop/tablet is integrated to STB. For example, a person can watch TV sourced by the STB on the laptop/tablet. The table (rotatable surface) angle can be adjusted based on the approaches mentioned in Step 1.

In an embodiment, the system includes a rotatable table and a sensor intended to be close to such table, so that they can be based on the viewer's location. That is, the table sensor can detect the movement and change in location of the viewer, such as described above. Then the table, mounted with a laptop or tablet for instance, can rotate to that particular location. The person does not have to adjust the screen their self. For instance, when the person is cooking in the kitchen and that person wants to move about the kitchen, the rotatable table moves in the direction of the person and the person does not need to move such things as the laptop or tablet.

In an embodiment, the rotatable table is generally the size of the laptop or tablet. Such rotatable table can be placed on a typical kitchen counter or table for instance. It can be placed on top on any surface like the kitchen table or counter.

In an embodiment, the rotatable table is configured with a rotatable motor. In an embodiment, the rotatable table is configured with a ball bearing mechanism, which is controlled by a controller for moving such as for rotating that particular system.

It should be appreciated that some embodiments are based on a noncamera approach. The noncamera approach alleviates privacy concerns of a user. That is, the viewer's location and position within the structure, such as within the living room, can be detected by the system without video recording the person at all.

In an embodiment, the system is configured to turn the monitor off and bring such monitor back into a normal or default placement or position in the case that no one is watching the monitor. In an embodiment, the controller determines that the monitor is turned off. In some embodiments, the controller can detect the status in various ways. In one embodiment, the controller can monitor the current it takes from the AC socket by installing a hall effect sensor on top of the existing system or by using a special plug which has a series current which measures the current and converts it to voltage. Such can be connected to the microcontroller and using an Analog to Digital Converter the embodiment can convert the current value to a number. This can be monitored to turn-off the TV. Another method is that to detect the remote power off/sleep button. If the STB is in power OFF or sleep state the information can be used to set the rotation motor to a default placement or position. The voice also can be one of the inputs. Subsequently, the controller transmits to the control motor a signal, wherein the signal comprises a default angle value or a default height value. Then, responsive to receiving such signal, the control motor adjusts the rotatable bracket to achieve the default angle value or adjusts the adjustable height pole to achieve the default height value.

In an embodiment, the system is configured to enable a user to use a microphone to give a voice command to turn the monitor/TV into a particular direction. In an embodiment, the remote or STB/TV can have any type of microphone depending on the sensitivity requirement of the system. The microphone (mic) can be connected to an audio encoder to convert the mic signals to digital format. Any open source audio to text conversion ML models can be used for getting the text from audio. Such model can be fine-tuned in the embodiment's usage environment to get higher accuracy.

In an embodiment, the system is configured to identify multiple viewing locations (e.g., couch, table next to couch, work out equipment next to table) and configured to identify when a user is stationary (e.g., for more than 30 seconds) in one of those locations while looking at the TV (monitor). The system is further configured to then move the TV in the better placement for the user. In this way, the TV is not seemingly always moving as people wander around a room.

Processing Artificial Intelligence Such as Machine Learning from Thermal Imaging

In an embodiment, the system is configured with one or more infrared sensors to detect a thermal image of a person and based on that the system can detect whether a person is moving from one place to another in a room. In an embodiment, the sensor can be placed in front of STB as an add-on card which can be connected to STB. Preferably, there is no or very little obstruction between the sensor and humans in the room. It can be integrated to front of STB itself also. The placement can be a wireless module also which can be placed anywhere in the room and communicate to the main controller by common wireless communication protocols.

In an embodiment, such thermal sensor described above detects live objects, such as people or pets. The data is sent to a machine learning algorithm. The ML is be placed on the main controller. In case of noise reduction and preliminary deduction it can also be placed on the edge of a smaller controller, but may have limited capability. The capability may depend on the final implementation architecture.

In an embodiment, over time, the machine learning algorithm learns the outline of the person(s) and can transmit particular parameters to the controller. Example relevant parameters include but are not limited to such as environment condition (e.g., temperature, humidity, light intensity), The TV channel information, and PIR sensor reading. Such parameters are given to the model as input. In an embodiment, the controller then sends one or more signals to the motors to adjust the TV height and angle towards the person. The communication can be using the methods described previously. In an embodiment, the subsidiary controller may need this information to adjust the position and angle. It should be appreciated that using infrared sensors has less privacy invasion than other methods such as using cameras.

### Employing Sensors Such as Passive Infrared (“PIR”) to Identify People's Movement

In an embodiment, the system is configured to employ and process a PIR sensor. Similarly to using the infrared sensor, the system is configured to detect the location or presence of the person on a room. Similar to IR array the PIR sensor can also be connected in array depending on the size of the room. It can be wired or wireless. If wired it can be connected to the main controller directly using protocols like I2C, SPI, CAN, etc. In the case of wireless configuration, it can also be WiFi, BLE, RF4CE, Zigbee, etc. where the main controller can have a similar interface. The parameter collected from the PIR sensor can be the PIR sensor value. An additional temperature sensor also can be used to collect the temperature data, similarly as in the case of thermal IR array which can be used to fine tune the ML model for accuracy.

In an embodiment, the system is configured with multiple PIRs, which increases the accuracy of the person. The method of connection is the same as in case of the thermal IR array.

### Employing Weight Sensors on Common Sitting Placements

In an embodiment, the system is configured with one or more weight sensors. The embodiment can be understood by way of example. Suppose a person has a normal sitting placement inside of a room, such as on a couch or at a table on a chair. Assume the person usually sits at either of those two places. Then, based on that knowledge, those two places are each assigned a weight. In an embodiment, the weight sensor is a physical weight sensor which can be placed at specific locations such as but not limited to under the couch legs or under the sitting placement as a sofa cushion. It can be placed on top of the sofa with some cloth covering so that it covers normal sitting placements of the customers. Such sensor gives a general idea of how many people are within close proximity such as for example sitting on sofa. The placement of sofa can be hard coded to the main controller by asking the customer to set the TV angle initially in comfortable angle or location while sitting on the sofa. Using software control the person is able to rotate the screen. An embodiment can allow automating the same by adding BLE (Bluetooth Low Energy) or UWB (Ultra Wide Band) controllers along with weight sensors which gives accurate location of the weight sensor in the room. In the case that manual adjustment is desired, either a wired or common wireless protocols can be used to interface with the weight sensor. The similar protocol receiver is added in main controller as well.

In an embodiment, when no one is sitting on the couch or on the chair, then each of these sensors have a constant weight. Thus, when a person is sitting on the couch for example, the weight is different. The difference in the weight is measured. The weight sensors typically are pressure sensors. Using a piezoelectric/capacitive/strain gauge sensor, etc., the pressure is measured and using the properties of sensor the pressure can be converted to weight. As an example, the couch weight can be assigned a value of five and a person is given a weight of 20. Further, assume the couch has four different sensors. For instance, the bottom of the couch can have four different holders, one for each weight sensor. Then, when a person sits in the left portion of the couch, the weight could be 50 KG. That is, there is a substantial amount of weight in the side of the weight sensor where the person is sitting. Based on the change and the amount of change in the weight sensor transmitted values, the system can determine on which side of the couch the person is sitting and send the appropriate signals to the controller to move adjust the TV. The weight sensors can be a small sensor module (wireless/wired) which will be in different size and shape and can be easily attached to a sofa, cushion etc., as described above.

Employing Sensors Based on Millimeter (“Mm”) Waves to Identify the Person's Position and/or Location

Similarly to using infrared waves and sensors, the system can be configured to employ millimeter (“mm”) waves. Millimeter waves have a higher frequency than the infrared and, thus, provide more accuracy. For instance, if the person is sitting on the couch, the system via mm waves can detect details such as the gesture of the person. In an embodiment, the mm wave sensor is placed on the STB, which can be substantially close to the TV so that the system can determine the height and angle of the person from that placement of the mm wave sensor.

### Using WiFi Based Location Tracking

In an embodiment, the system is configured to receive and process typical WiFi signals used for communication. For example, the STB typically is configured to have WiFi, to transmit WiFi signals. In an embodiment, the modern STB uses the internet for streaming live content other than satellite input. Use cases for this situation include Ethernet and WiFi. The device is connected to a main router in the house through either means and stream the contents.

In an embodiment, the system is configured to detect such STB WiFi signals. In the case of using an auxiliary controller, the system can use either a WiFi hotspot from STB or it can use the home WiFi infrastructure to connect to the same WiFi network and communicate in between. In an embodiment, the configuration can be similar to on-boarding an IoT device to one's existing WiFi.

In an embodiment, the data from the received signals are then sent over a network to the cloud. Herein, the cloud represents cloud computing, which is a network of servers and databases stored on the internet as opposed to locally. In the case of cloud access the structure, such as the home, has an internet connection. The STB can connect to the internet and send the data over to cloud services such as but not limited to Amazon Web Services (AWS) and process the data inside the AWS such as applying a ML algorithm.

In an embodiment, the system is configured with a machine learning algorithm at the cloud or at the controller, which, given the received data, can detect the presence of the person in the room or the movement of the person in the room. In an embodiment, such machine learning algorithms can be used to detect the identity of the person and create and update a profile of such person. The profile can be used by the system to predict where the person might sit in the room and cause the display to automatically adjust to the appropriate height and angle for that person. Using the latest ML algorithm the system identifies a person in a room and locates that person. After processing the result is sent back to STB. The STB is also configured to perform some minor modification of the result as per the ML architecture.

In an embodiment, the controller determines one of a location or position based upon receiving and processing the signal, and supplements with the undetermined part. More specifically, it can happen that the controller parsing a received signal can determine one of the location or position of the user. In these cases, when the location is determined by the controller from the information in the signal but the position cannot be determined by the controller from the information in the signal, the controller determines the position based on supplemental information. Likewise, when the position is determined by the controller from the information in the signal but the location cannot be determined by the controller from the information in the signal, the controller determines the location based on supplemental information such as for example a user profile. Examples of supplemental information include but are not limited to information in profiles. For instance, the controller can look up a temporal profile, a profile indicating likelihood of location and position based on time of day. As another example, the controller can look up user profiles when the user has detected the identity of the person in the room.

In an embodiment, advanced algorithms can detect the person's identity and used such information to track the person's movement. The STB collects the data and preprocesses such data. Then, the preprocessed data are sent to the cloud for the final analysis, as, typically, such analysis requires more processing power. Thus, help of the cloud is leveraged. In an embodiment, this process is completed full and in real time. The architecture of the ML application uses semi-supervised learning to identify the person. The existing model is then fine-tuned based on the use cases and receiver properties. Thus, for instance, when a person moves to the chair from the couch, the before-mentioned activity is happening, being processed by the system. The data collection is performed on the TV or an accessory and then sent to the cloud. The cloud performs the calculation and sends the results back to the TV and then the TV adjusts accordingly.

In an embodiment, the steps described above for location and/or position tracking is performed on the STB or accessory directly. The STB collects the WiFi signal, which has a pattern based on each person's body type and activities. The WiFi signal variations can be different. In an embodiment, the STB is collecting this variation and sending such over to a cloud machine. In that machine, a process analyzes this signal pattern and associates it with a person/activity. Such algorithms can be complex as they have to detect very small change in the signal and map either the change or the signal to different classes. Each class contains an identity/action.

By Using the Remote Device for the Monitor, the Location and/or Position of the User can be Identified

In an embodiment, the remote device (“remote”), which is used to change channels on a TV (monitor), is used to track the person, because typically the remote is close in proximity to the person. In an embodiment, the remote is a BLE remote. Such remote is then an indoor (or other smaller, close section where BLE is effective) location and/or positioning system. Similar to using the STB to locate the location and/or position of the user, the system is configured to locate the placement of the remote by using the BLE technology. Then, based on the placement of the remote, the system can identify the location and/or position of the person from the TV. In an embodiment, a tag is placed on the remote and a corresponding sensor for such tag is on the STB or on an accessory to the STB. In an embodiment, the STB is configured to BLE location finding technology that is used for identifying the location of the remote. The BLE transceiver can be either independent or be connected to the controller of the remote controller. Along with the remote operation the BLE device can use the Angle of Arrival (AoA) or Angle of Departure (AoD) feature of the BLE technology to determine the angle of the remote from STB. With this mechanism along with the triangulation method the system can identify the remote location.

### The Person Carries an Accessory

In an embodiment, the person can carry an accessory such as but not limited to ultra wideband (“UWB”) or Bluetooth® Low Energy (“BLE”) based tags, smart watch, phone, etc. Such accessories are able to detect whether the person is wearing it by the accelerometer and gyrometer inside it. The accelerometer and gyrometer detect motion and rotation. When a person moves from one location to another the system can read output of these sensors and determine the change in location. Thus, the system can detect the person when the person moves. From this detection, the system can determine whether the device is actually carried by the person or not. Once such detection is identified the system can use the other sensors as described to detect the persons location.

In an embodiment, the system detects tags, e.g., UWB or BLE based tags, where the person carries the tags with them, similar to a person carries car keys in their pocket and they can walk around. As described below, the system can determine the location of the person, using some sensors in the STB. For example, techniques described above can be extended to the smartwatch, where the smartwatch has BLE connectivity. Or, techniques can be extended to the phone, which allows Wi-Fi, GPS, and BLE sensor technologies. In an embodiment, the STB is configured with one or more receivers to communicate via such described sensor technology of the accessories. In an embodiment, the STB is further configured to communicate with the controller to cause the TV/monitor stand motors to adjust the height or angle of the TV/monitor mounted on the stand.

In an embodiment, the system is configured to determine whether the accessory is moving or not, then whether the person is moving from one place to another, using the output from the accelerometer or gyrometer sensors as mentioned above. The sensors can be third party devices such as phone, tags, etc. Each of these devices can have a unique identifier (ID), which can help to identify a person. The remote also can have the accelerometer, which can be used to identify whether it is picked up by a person.

Using a Camera where there are No Security Concerns

An embodiment includes a camera when there are no security concerns for the person. Examples of areas where the system can include a camera include but are not limited to common areas such as a gym and a cafeteria. In an embodiment, the system is configured to use a camera to identify the people and adjust the TV based on the people's location and/or position. In an embodiment, a 360° camera, where the whole area can be detected, can be used by the system to determine to where or to which place the TV has to move to get a better view for the people. In an embodiment, the system is configured to use the data from the TV and determine people's location therefrom using object detection. The camera visibility can depend on the room. The camera can be chosen according to visibility required. For example, if the normal sitting placement is only the couch, the camera can detect only that location. When the normal placements are the couch and a table, the camera can be placed such that it covers both places. Also multiple cameras can be connected and marked in the STB to different locations. The captured images then run through a ML human detection algorithm where it can detect human presence. From this output, the system can get the relative location of the human in picture. This picture or information can in turn give the location of people with respect to the camera. In an embodiment, the system processes fine-tuning while installing the camera. The placement is fed into the STB manually or the camera can also use location tracking sensors so that the STB can detect its location. Also the camera can be wired for example a USB or an IP camera which works over a Ethernet/WiFi network can be employed.

### Placement of Sensors

In an embodiment, each type of sensor described above is placed inside the STB. In another embodiment, the sensor is an accessory to the existing STB. As described above, the sensors can be connected to the STB over various technologies such as but not limited to USB, CAN, RS485, RS232, Ethernet etc. Such are the present day wired technologies. These methods can power the sensors which avoids the need of battery. In case of wireless technologies such as but not limited to UWB, BLE, RF4CE, WiFi, a power supply is needed separately such as battery or wall adapters. The sensors can use these protocols to share the collected data with the main controller. The main controller can interpret the data and after filtering can send such information to the cloud for processing or process such information locally to get the customer location and/or position with respect to the TV.

### Adjusting the Monitor Angle or Height

In an embodiment, the system is configured to adjust the height pole, which can be mounted to the wall. Both height of the TV as well as angle can be adjusted. The TV/monitor can be mounted to the stand described above. Each of the height pole and the rotatable bracket on the stand are communicably connected to a controller, which sends signals for them to adjust, respectively. This stand has a motor that is controlled electronically and rotates the angle, which was already calculated by the system, using the previous methods. In an embodiment, when the TV is mounted closely to the wall, a particular holder is used to mount the TV on the wall. The holder can be retractable where in OFF mode the TV is close to the wall and when the TV is powered ON the bracket can use the built-in motors to project the TV from wall to a safe distance and rotate the TV based on the sensor inputs.

In an embodiment, the TV/monitor is mounted onto a wall that is rotatable. Such wall is communicably connected to a motor. The motor is communicably connected to a controller, such as described above. Thus, for example, a rotatable door is contemplated. In this example, a person can watch the TV in their bedroom that is connected to a hall. When the wants to switch the TV from the hall to the bedroom, they can just rotate the wall based on the user's preference, where the wall is made of a small piece of wood.

### Controllers and Motors

In an embodiment, the STB is configured with a main controller for performing the bulk of the processing, such as calculating the values to adjust the angle or the height of the TV. The motor to adjust the angle and the motor to adjust the height each have a controller that is close to them, in the sense that such controller can be communicably connected to the motor (e.g., BLE, WiFi, Zigbee, wired technology, etc.). In an embodiment, the rotatable bracket and the adjustable height pole are each configured with a controller and a motor. The wired technology can provide power to the motor system as well. Wireless technology may require a separate wall adapter or battery.

### Suitable System

The techniques disclosed herein can be embodied as special-purpose hardware (e.g., circuitry), as programmable circuitry appropriately programmed with software and/or firmware, or as a combination of special-purpose and programmable circuitry. Hence, embodiments may include a machine-readable medium having stored thereon instructions which may be used to cause a computer, a microprocessor, processor, and/or microcontroller (or other electronic devices) to perform a process. The machine-readable medium may include, but is not limited to, optical disks, compact disc read-only memories (CD-ROMs), magneto-optical disks, ROMs, random access memories (RAMs), erasable programmable read-only memories (EPROMs), electrically erasable programmable read-only memories (EEPROMs), magnetic or optical cards, flash memory, or other type of media/machine-readable medium suitable for storing electronic instructions.

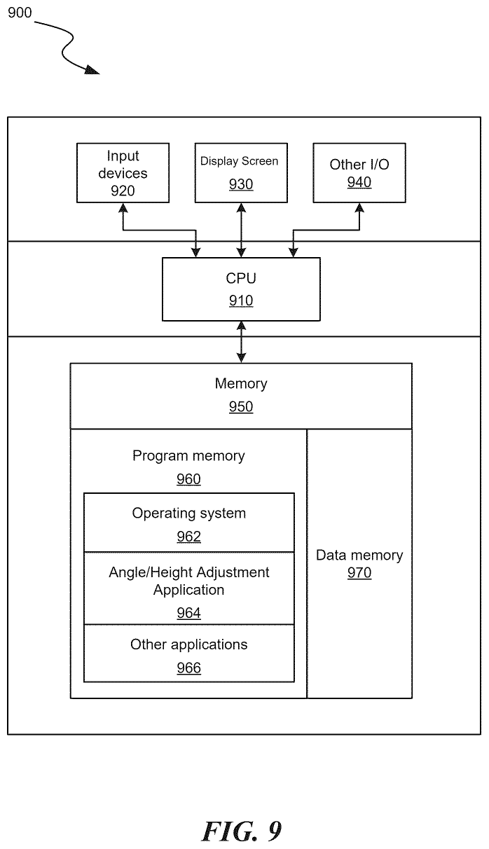

Several implementations are discussed below in more detail in reference to the figures. FIG. 9 is a block diagram illustrating an overview of devices on which some implementations of the disclosed technology can operate. The devices can comprise hardware components of a device 900. Device 900 can include one or more input devices 920 that provide input to the CPU (processor) 910, notifying it of actions. The actions are typically mediated by a hardware controller that interprets the signals received from the input device and communicates the information to the CPU 910 using a communication protocol. Input devices 920 include, for example, a mouse, a keyboard, a touchscreen, an infrared sensor, a touchpad, a wearable input device, a camera- or image-based input device, a microphone, or other user input devices.

CPU 910 can be a single processing unit or multiple processing units in a device or distributed across multiple devices. CPU 910 can be coupled to other hardware devices, for example, with the use of a bus, such as a PCI bus or SCSI bus. The CPU 910 can communicate with a hardware controller for devices, such as for a display screen 930. Display screen 930 can be used to display text and graphics. In some examples, display screen 930 provides graphical and textual visual feedback to a user. In some implementations, display screen 930 includes the input device as part of the display, such as when the input device is a touchscreen or is equipped with an eye direction monitoring system. In some implementations, the display is separate from the input device. Examples of display devices are: televisions; mobile devices; an LCD display screen; an LED display screen; a projected, holographic, or augmented reality display (such as a heads-up display device or a head-mounted device); and so on. Other I/O devices 940 can also be coupled to the processor, such as a network card, video card, audio card, USB, FireWire or other external device, camera, printer, speakers, CD-ROM drive, DVD drive, disk drive, or Blu-Ray device.

In some implementations, the device 900 also includes a communication device capable of communicating wirelessly or wire-based with a network node. The communication device can communicate with another device or a server through a network using, for example, TCP/IP protocols. Device 900 can utilize the communication device to distribute operations across multiple network devices.

The CPU 910 can have access to a memory 950. A memory includes one or more of various hardware devices for volatile and non-volatile storage, and can include both read-only and writable memory. For example, a memory can comprise random access memory (RAM), CPU registers, read-only memory (ROM), and writable non-volatile memory, such as flash memory, hard drives, floppy disks, CDs, DVDs, magnetic storage devices, tape drives, device buffers, and so forth. A memory is not a propagating signal divorced from underlying hardware; a memory is thus non-transitory. Memory 950 can include program memory 960 that stores programs and software, such as an operating system 962, an angle/height adjustment application 964, and other application programs 966. Memory 950 can also include data memory 970 that can include speaker information, etc., which can be provided to the program memory 960 or any element of the device 900.

Some implementations can be operational with numerous other general purpose or special purpose computing system environments or configurations. Examples of well-known computing systems, environments, and/or configurations that may be suitable for use with the technology include, but are not limited to, personal computers, server computers, handheld or laptop devices, cellular telephones, mobile phones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

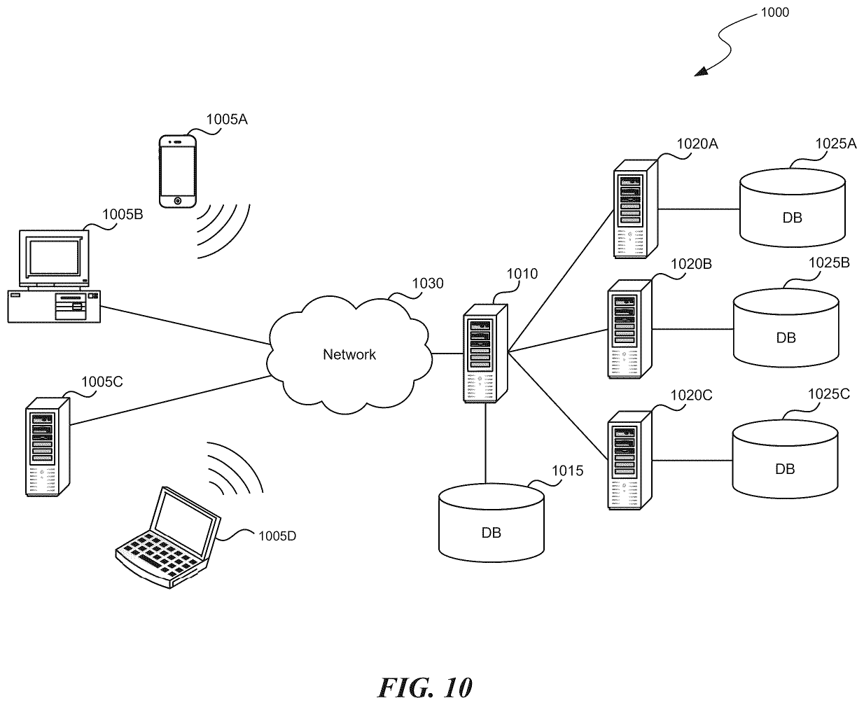

FIG. 10 is a block diagram illustrating an overview of an environment 1000 in which some implementations of the disclosed technology can operate. Environment 1000 can include one or more client computing devices 1005A-D, examples of which can include controller 316. Client computing devices 1005 can operate in a networked environment using logical connections through network 1030 to one or more remote computers, such as a server computing device 1010.

In some implementations, server computing device 1010 can be an edge server that receives client requests and coordinates fulfillment of those requests through other servers, such as servers 1020A-C. Server computing devices 1010 and 1020 can comprise computing systems, such as controller 316. Though each server computing device 1010 and 1020 is displayed logically as a single server, server computing devices can each be a distributed computing environment encompassing multiple computing devices located at the same or at geographically disparate physical places. In some implementations, each server computing device 1020 corresponds to a group of servers.

Client computing devices 1005 and server computing devices 1010 and 1020 can each act as a server or client to other server/client devices. Server 1010 can connect to a database 1015. Servers 1020A-C can each connect to a corresponding database 1025A-C. As discussed above, each server 1020 can correspond to a group of servers, and each of these servers can share a database or can have their own database. Databases 1015 and 1025 can warehouse (e.g., store) information such as speaker information, speaker characteristics (e.g., frequency range and/or timing delay), channel selections, and/or user preferences. Though databases 1015 and 1025 are displayed logically as single units, databases 1015 and 1025 can each be a distributed computing environment encompassing multiple computing devices, can be located within their corresponding server, or can be located at the same or at geographically disparate physical places.

Network 1030 can be a local area network (LAN) or a wide area network (WAN), but can also be other wired or wireless networks. Network 1030 may be the Internet or some other public or private network. Client computing devices 1005 can be connected to network 1030 through a network interface, such as by wired or wireless communication. While the connections between server 1010 and servers 1020 are shown as separate connections, these connections can be any kind of local, wide area, wired, or wireless network, including network 1030 or a separate public or private network.

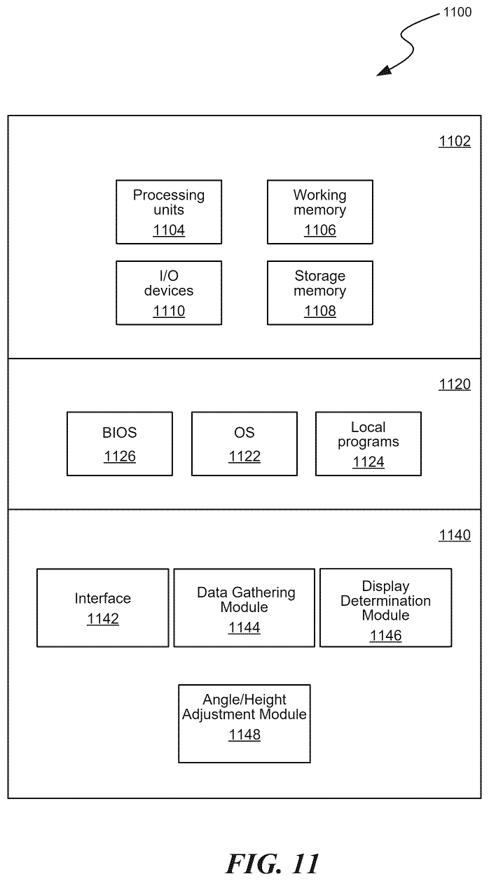

FIG. 11 is a block diagram illustrating components 1100 which, in some implementations, can be used in a system employing the disclosed technology. The components 1100 include hardware 1102, general software 1120, and specialized components 1140. As discussed above, a system implementing the disclosed technology can use various hardware, including processing units 1104 (e.g., CPUs, GPUs, APUs, etc.), working memory 1106, storage memory 1108, and input and output devices 1110. Components 1100 can be implemented in a client computing device such as client computing devices 1005 or on a server computing device, such as server computing device 1010 or 1020.

General software 1120 can include various applications, including an operating system 1122, local programs 1124, and a basic input output system (BIOS) 1126. Specialized components 1140 can be subcomponents of a general software application 1120, such as local programs 1124. Specialized components 1140 can include a Data Gathering module 1144, Display Determination module 1146, Angle/Height Adjustment module 1148, and components that can be used for transferring data and controlling the specialized components, such as interface 1142. In some implementations, components 1100 can be in a computing system that is distributed across multiple computing devices or can be an interface to a server-based application executing one or more of specialized components 1140.

Those skilled in the art will appreciate that the components illustrated in FIGS. 9-11 described above, and in each of the flow diagrams discussed above, may be altered in a variety of ways. For example, the order of the logic may be rearranged, sub steps may be performed in parallel, illustrated logic may be omitted, other logic may be included, etc. In some implementations, one or more of the components described above can execute one or more of the processes described below.

### Remarks

The above description and drawings are illustrative and are not to be construed as limiting. Numerous specific details are described to provide a thorough understanding of the disclosure. However, in some instances, well-known details are not described in order to avoid obscuring the description. Further, various modifications may be made without deviating from the scope of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. It will be appreciated that the same thing can be said in more than one way. Consequently, alternative language and synonyms may be used for any one or more of the terms discussed herein, and any special significance is not to be placed upon whether or not a term is elaborated or discussed herein. Synonyms for some terms are provided. A recital of one or more synonyms does not exclude the use of other synonyms. The use of examples anywhere in this specification, including examples of any term discussed herein, is illustrative only and is not intended to further limit the scope and meaning of the disclosure or of any exemplified term. Likewise, the disclosure is not limited to various embodiments given in this specification. Unless otherwise defined, all technical and scientific terms used herein have the same meaning as commonly understood by one of ordinary skill in the art to which this disclosure pertains. In the case of conflict, the present document, including definitions, will control.

1. A method comprising:
receiving, at a controller, a first signal from a device wherein the first signal comprises information about at least one of a location or a position of a user;
determining, by the controller, at least one of the location or the position of the user based on the information in the first signal;
determining, by the controller, at least one of an adjusted height value or an adjusted angle value of a monitor based on the at least one of the location or the position of the user;
sending by the controller to a control motor, a second signal, wherein the second signal comprises at least one of the adjusted angle value or the adjusted height value;
responsive to receiving the second signal, the control motor performing at least one of:
adjusting a rotatable bracket based on the adjusted angle value; or
adjusting an adjustable height pole based on the adjusted height value;
wherein the rotatable bracket and the adjustable height pole are communicably connected to the control motor.

2. The method of claim 1, wherein the device is a thermal sensor and the information comprises one or more thermal images of the user;
wherein determining the at least one of the location or the position of the user further comprises:
inputting, by the controller, the thermal images into a machine learning algorithm and obtaining from the machine learning algorithm a predicted adjusted height value or a predicted adjusted angle value of the monitor; and
assigning the predicted adjusted height value or the predicted adjusted angle value of the monitor to the adjusted height value or adjusted angle value of the monitor.

3. The method of claim 1, wherein the device is a motion detector sensor and the information about the at least one of the location or the position of the user indicates movement detected with a line of sight of the motion detector sensor.

4. The method of claim 1, wherein the device is a weight sensor and the information about the at least one of the location or the position of the user comprises a weight value, the method further comprising:
comparing the weight value with a threshold weight value;
determining that the weight value is greater than the threshold value; and
assigning a predetermined adjusted height value or a predetermined adjusted angle value of the monitor to the determined adjusted height value or adjusted angle value of the monitor.

5. The method of claim 1, wherein the device is a millimeter wave sensor and the information about the at least one of the location or the position of the user comprises a range, a velocity, and an angle of the user.

6. The method of claim 1, wherein the device is a Wi-Fi-based device, the information about the at least one of the location or the position of the user is a detection signal, signaling presence of a person, and determining the at least one of the location or the position of the user further comprises:
transmitting information indicating the detection signal to the cloud; and
receiving from the cloud at least one of the location or the position of the user.

7. The method of claim 1, wherein the device is a remote controller, the information about the at least one of the location or the position of the user comprises information about a location of the remote control, and determining the at least one of the location or the position of the user is further based on the location of the remote control.

8. The method of claim 1, wherein the device is a device worn or carried by the user.

9. The method of claim 8, wherein the device is any of:
a device comprising ultra wideband or low energy based tags;
a smart watch; and
a digital phone;
wherein the device is configured with an accelerometer or a gyro meter.

10. The method of claim 1, wherein the device is a camera.

11. The method of claim 1, wherein the controller is configured into a first set-top box.

12. The method of claim 11, further comprising:
receiving, at a second controller, a third signal from the device wherein the third signal comprises information about at least one of a new location or a new position of the user, wherein the second controller is configured into a second set-top box in a room different than a room of a location of the first set-top box, and
automatically streaming content on the second set-top box based on the content that was streaming on first set-top box.

13. The method of claim 1, wherein the monitor is a TV, laptop, or tablet.

14. The method of claim 1, further comprising:
determining, by the controller, that the monitor is turned off;
sending by the controller to the control motor, a fourth signal, wherein the fourth signal comprises at least one of a default angle value or a default height value;
responsive to receiving the fourth signal, the control motor performing at least one of:
adjusting the rotatable bracket to achieve the default angle value; or
adjusting the adjustable height pole to achieve the default height value.

15. The method of claim 1, further comprising:
receiving, by the controller, a voice command to turn the monitor into a particular direction, the voice command comprising at least one of a vocalized height value or a vocalized angle value; and
determining, by the controller, the adjusted height value or the adjusted angle value of a monitor based on the at least one of vocalized height value or the vocalized angle value.

16. The method of claim 1, further comprising:
responsive to determining, by the controller, the at least one of the location or the position of the user based on the information in the first signal and before determining, by the controller, the at least one of the adjusted height value or the adjusted angle value of a monitor based on the at least one of the location or the position of the user, confirming that a predetermined amount of time has passed and that the at least one of the location or the position of the user has not changed.

17. The method of claim 1, further comprising:
receiving, at the controller, a fifth signal from a second device wherein the fifth signal comprises information about at least one of a location or a position of a second user;
determining, by the controller, the at least one of the location or the position of the second user based on the information in the fifth signal; and
wherein determining, by the controller, at least one of an adjusted height value or an adjusted angle value of a monitor based on the at least one of the location or the position of the user further comprises incorporating the at least one of the location or the position of the second user.

18. The method of claim 1, further comprising:
when the location is determined by the controller from the information in the first signal but the position is not determined by the controller from the information in the first signal, the controller:
determining the position based on a user profile; and
sending the position to the control motor; and
when the position is determined by the controller from the information in the first signal but the location is not determined by the controller from the information in the first signal, the controller:
determining the location based on the user profile; and
sending the location to the control motor.

19. A system, comprising:
a controller configured to receive a first signal from a device wherein the first signal comprises information about at least one of a location or a position of a user;
wherein the controller is configured to determine at least one of the location or the position of the user based on the information in the first signal;
wherein the controller is configured to determine at least one of an adjusted height value or an adjusted angle value of a monitor based on the at least one of the location or the position of the user;
wherein the controller is configured to send to a control motor, a second signal, wherein the second signal comprises at least one of the adjusted angle value or the adjusted height value; and
a control motor configured to, responsive to receiving the second signal, adjust a rotatable bracket based on the adjusted angle value; or
adjust an adjustable height pole based on the adjusted height value;
wherein the rotatable bracket and the adjustable height pole are communicably connected to the control motor.

20. A method comprising:
predicting, by a controller, at least one of a location or a position of a user based on a profile of the user;
determining, by the controller, at least one of an adjusted height value or an adjusted angle value of a display based on the at least one of the location or the position of the user;
sending by the controller to a control motor, a first signal, wherein the first signal comprises the at least one of the adjusted angle value or the adjusted height value;
responsive to receiving the first signal, the control motor performing at least one of:
adjusting a rotatable display bracket based on the adjusted angle value; or
adjusting an adjustable height pole based on the adjusted height value;
wherein the rotatable display bracket and the adjustable height pole are each communicably connected to the control motor.
